(19) United States
(12) Patent Application Publication
(10) Pub. No.: US 2014/0078289 A1
(43) Pub. Date: Mar. 20, 2014

(54) Die Bonder and Method of Position Recognition of Die

(71) Applicant: HITACHI HIGH-TECH INSTRUMENTS CO., LTD., Kumagaya-shi (JP)

(72) Inventors: Ryo OMORI, Kumagaya-shi (JP); Hideharu KOBASHI, Kumagaya-shi (JP)

(73) Assignee: HITACHI HIGH-TECH INSTRUMENTS CO., LTD., Kumagaya-shi (JP)

(21) Appl. No.: 13/780,065

(22) Filed: Feb. 28, 2013

(30) Foreign Application Priority Data
Sep. 18, 2012 (JP) 2012-204006

(51) Int. Cl. G06T 7/00; H04N 7/18

(52) U.S. Cl. CPC G06T 7/004; H04N 7/18
USPC 348/87; 382/103

(57) ABSTRACT

A die bonder comprises a storage unit which stores the image of the wafer taken by an imaging unit, a recognition pattern included the outline of a die formed on the wafer, and a recognition program, and a monitor-processing unit which gets the position on the wafer, of the die whose map data indicates normal, in the way that the die is matched with the recognition pattern by executing the recognition program, and that the center position of the die is gotten.

Thus, the die bonder can recognize the position of the die without regard to the condition of dies on the wafer.

### CLAIMS OF PRIORITY

The present application claims priority from Japanese patent application serial no. JP2012-204006, filed on Sep. 18, 2012, the content of which is hereby incorporated by reference into this application.

### BACKGROUND OF THE INVENTION

The present invention relates to a die bonder, and a method of position recognition of a die, and particularly to a die bonder, and a method of position recognition of a die suitable for recognizing the position of dies on a wafer precisely, and picking up the dies securely.

A die bonder, which bonds semiconductor chips (dies) to a substrate, is known as one of manufacturing apparatus. The die bonder attracts a die with vacuum chuck by a bonding head, and the bonding head lifts up at high speed, moves horizontally, goes down, and mounts it to a substrate. When the bonding head attracts the die with vacuum chuck, it is necessary to pick up the die firmly. Recently, the demand becomes higher as thinning of dies. Therefore, the die bonder recognizes the position of the die, and detects a deviation, then, calibrates the position of the bonding head, thus the bonding head picks up the die. As methods of recognizing the position of dies, for example, there exits arts shown in Japanese Patent Application Laid-open 2003-188193, and 2011-061069. Japanese Patent Application Laid-open 2003-188193 discloses, as shown in FIG. 5(a), the method of recognizing the position of dies by matching pattern between imaging data at unique portions Pa of alignment marks of dies M, or of pad BP, and template acquired beforehand with teaching motions. On the other, Japanese Patent Application Laid-open 2011-061069 discloses, as shown in FIG. 5, the method of getting the center position of dies by executing digital processing etc. for imaging data of dies, recognizing the grooves of dicing which divide many dies formed on a wafer into each part.

A die bonder picks up normal dies on the basis of information indicating normal or abnormal of dies, called map data.

A process to pick up a normal die will be described using FIG. 7.

FIG. 7 is a figure for explaining a condition of dies.

It is assumed that normal dies are die a, and die f.

Then, the system, after getting the center position of die a, gets the center position of the next die, die b, die c, die d in succession, and reaches the center position of die f, Here, because it is possible that position aberration etc. occurs with regard to die b, die c, and die d, the system needs to get the center positions of b, die c, and die d precisely in order to reach the center position of die f from the center position of die a. Moreover, on the path, because it is possible to break the pattern of a die, the system needs to deal with such a case.

As methods of recognizing dies, there are the methods of using pattern recognition, and of using the outline of a die. According to the method of using pattern recognition, it is necessary to register the template in accordance with each pattern of dies. Moreover, when using the outline of a die, it may occurs that the outline of the die on all sides is not clear, in this case, the system cannot use the method of using the outline of a die.

The present invention has been devised to solve the above-described problems, and an object of the present invention is to provide a die bonder which can recognize the position of a die precisely without regard to the condition of the die.

### SUMMARY OF THE INVENTION

A die bonder of the present invention comprises: a imaging unit which takes an image of a wafer; a storage unit which stores the image of the wafer taken by the imaging unit, a recognition pattern included the outline of a die formed on the wafer, and a recognition program; an interface unit which received map data indicated that the die is normal or abnormal; and a monitor-processing unit which gets the position on the wafer, of the die whose map data indicates normal, in the way that the die is matched with the recognition pattern by executing the recognition program, and that the center position of the die is gotten.

And the recognition pattern is the pattern included the outline, the monitor-processing unit matches the die on the wafer with the recognition pattern, by executing the recognition program, gets the center position of the die, and gets the position of the die whose map data is normal.

Here, the recognition pattern is only one kind, and is used in order to get the center position of the die without regard to whether map data corresponded to the die is normal or abnormal.

And the center position of the die is gotten by dicing grooves formed on the wafer, when the recognition patters and a pattern of the die is not comparable.

### BRIEF DESCRIPTION OF DRAWINGS

FIG. 1 is a top view of a die bonder according to an embodiment of the present invention.

FIG. 2 is a diagram of an optical system according to an embodiment of the present invention.

FIG. 3 is a scheme diagram of control system 40.

FIG. 4 is a conception diagram described the construction of devices related to map data.

FIG. 5 is a figure described the way of a die position recognition of a die bonder in a wafer.

FIG. 6 is a flow chart described the processes of a die position recognition of a die bonder in a wafer.

FIG. 7 is a figure for explaining a condition of dies.

### DESCRIPTION OF THE PREFERRED EMBODIMENT

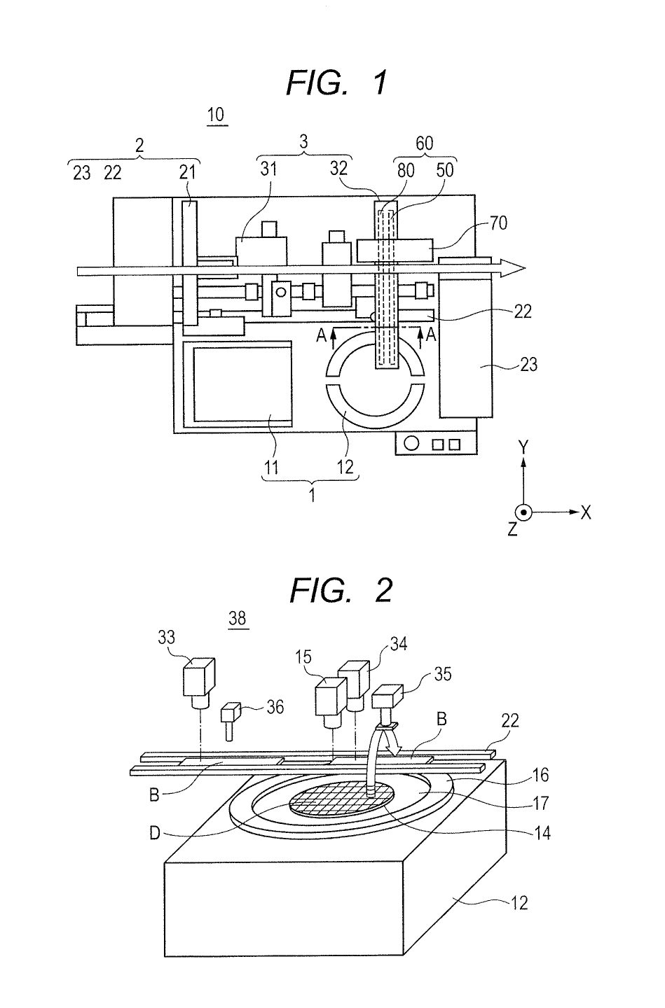

Hereinafter, a die bonder according to an embodiment of the present invention will be described using FIG. 1 to FIG. 6.

In the first place, a structure of the die bonder according to an embodiment of the present invention will be described using FIG. 1 to FIG. 3.

FIG. 1 is a top view of a die bonder according to an embodiment of the present invention.

FIG. 2 is a diagram of an optical system according to an embodiment of the present invention.

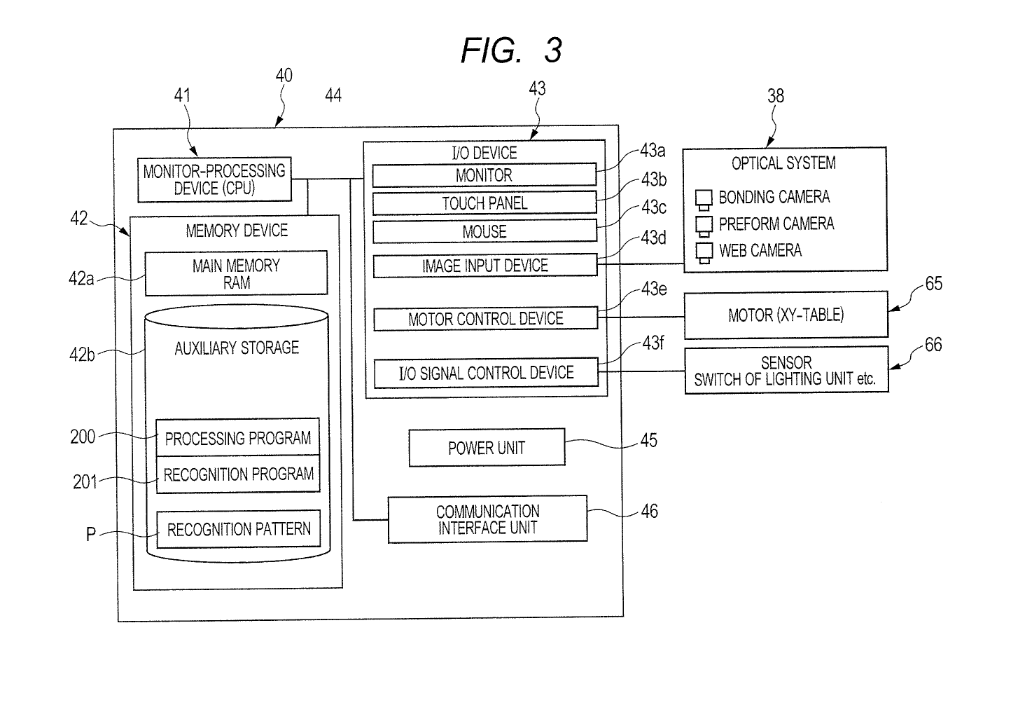

FIG. 3 is a scheme diagram of control system 40.

A die bonder 1, roughly speaking, includes a wafer supplying unit 10, a work supplying/delivering unit 2, and a die bonding unit 3.

The wafer supplying unit 10 includes a wafer cassette lifter 11 and a pick up device 12. The wafer cassette lifter 11 has a wafer cassette (not shown) into which a wafer ring is loaded, and supplies the wafer ring to the a pick up device 12 in sequential. The pick up device 12 moves the wafer ring so as to pick up a desired die from the wafer ring.

The work supplying/delivering unit 2 includes a stack loader 21, a frame feeder 22, and an unloader 23, delivers a work (substrate such as a lead frame etc.) in the arrow direction. The stack loader 21 supplies the work to be bonded a die. The frame feeder 22 delivers the work to the unloader 23 through two processing places of delivery on the frame feeder 22. The unloader 23 keeps the delivered work.

The die bonding unit 3 includes a preform unit (paste coating unit) 31 and a bonding head unit 32. The preform unit 31 coats the work delivered by the frame feeder 22, for example, a lead frame, with die paste by a needle. The bonding head unit 32 picks up a die from the pick up device 12, lifts up, and allows the die to move to a bonding point on the frame feeder 22. Then, the bonding head unit 32 allows the die to drop the die at the bonding point, and bonds the die on the work coated the die paste.

The bonding head unit 32 includes a ZY driving axis 60 which allows a bonding head 35 (refer FIG. 2) to go up and down in Z (height) direction and to move in Y direction, and a X driving axis 70 which allows the bonding head 35 to move in X direction. The ZY driving axis 60 includes a Y driving unit 80 which allows the bonding head 35 to move in Y direction, that is, to reciprocate between the pick up position in the pick up device 12 and the bonding point. The X driving axis 70 allows the ZY driving axis 60 as whole to move in X direction, the direction in which the work is delivered.

An optical system 38, as shown in FIG. 2, includes a preform unit optical system 33 that grasps the paste position by a needle 36, a bonding unit optical system 34 that grasps the bonding point at which the bonding head 35 bonds a die D to a delivered substrate B, and a wafer optical system 15 that grasps the pick up position at which the bonding head 35 picks up the die D. Each optical system includes a illuminator to illuminate an object, and a camera. The die D, which is sliced in mesh condition on the wafer 14, is fixed to a dicing tape 17 fixed to a wafer ring 16.

By this construction, the die paste is pasted the correct position by the needle 36, the die D is picked up certainly by the bonding head 35, and bonded to the correct position on the substrate B.

A control system 40, as shown in FIG. 3, roughly speaking, includes a monitor-processing device 41 mainly comprised CPU, a memory device 42, an I/O device 43, a bus line 44, a power unit 45, and a communication interface unit 46.

The memory device 42 includes a main memory 42a comprised a RAM that stores a processing program, an auxiliary storage 42b that stores control data for control and image data etc. such as a HDD (Hard Disk Drive) or a SSD (Solid State Drive).

The I/O device 43 includes a monitor 43a for displaying the condition of the devices or information etc., a touch panel 43b for inputting the command from an operator, a mouse 43c for operating the monitor, an image input device 43d, a motor control device 43e for inputting the signal from a signal unit 66, namely, a switch of signal for various sensors or illuminators etc., and for controlling. The monitor-processing device 41 acquires necessary data via the bus line 44, calculates, and transfers information to the monitor 43a etc.

The communication interface unit 46 is the unit for communicating to an outer system, or device.

The auxiliary storage 42b is stored a processing program 200 to control units in the die bonder 10, a recognition program 201 to recognize the die D, and a recognition pattern P of the die D. It is assumed that the recognition program 201 has the function generating the recognition pattern P of the die D.

The processing program 200 and the map data M are loaded in the main memory 42a, and executed by the monitor-processing device 41.

The recognition pattern P of the die D is the data that recognition program refers to, when recognizing the position of the die on a wafer.

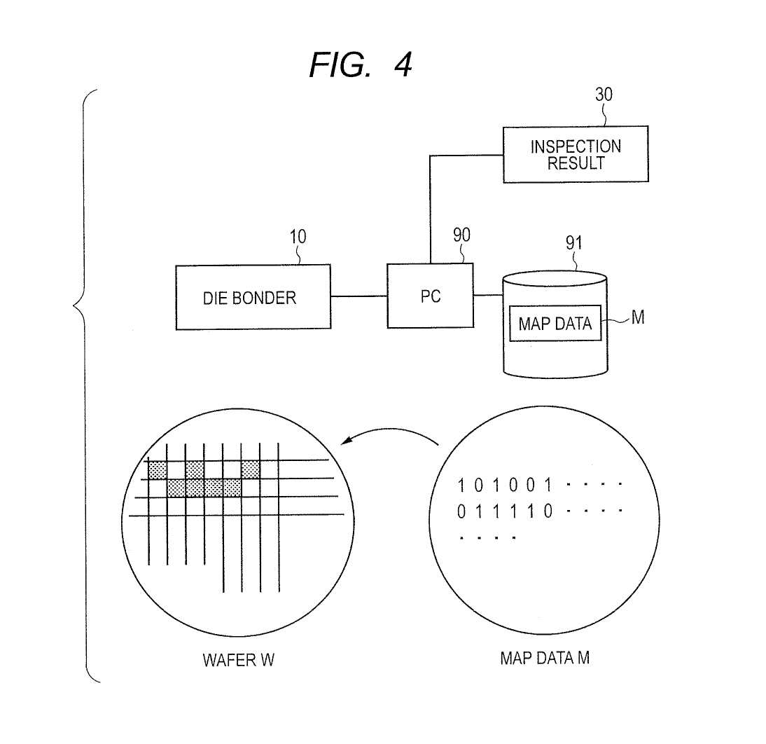

Next, the construction of devices related to map data will be described using FIG. 4.

FIG. 4 is a conception diagram described the construction of devices related to map data.

A die bonder 10 is connected to an outer PC (Personal Computer) 90 via the communication interface unit 46.

A wafer W is inspected by an inspection device 30 at each die, map data M indicated normal/abnormal at each die are generated, and sent to the PC 90. The map data M are the data that are generated when the outer PC inspects the Wafer, and keep information indicated normal/abnormal at each die. Then the map data M are stored temporarily to an auxiliary storage 91 connected to the outer PC 90, thereafter, transferred to the die bonder 10.

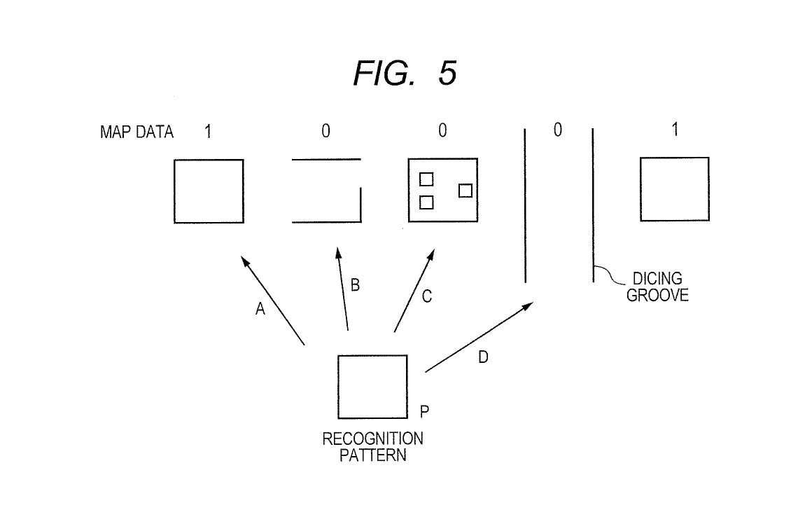

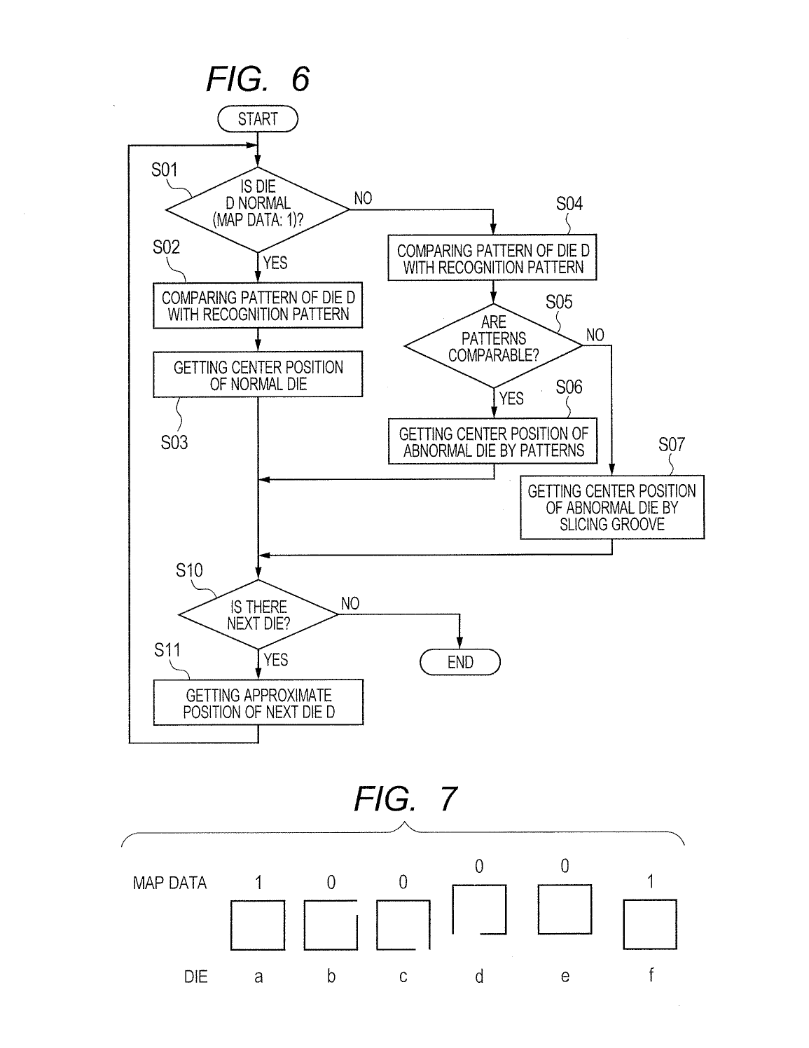

Next, a method of the die position recognition related to the die bonder according to one embodiment of the present invention using FIG. 5 and FIG. 6.

FIG. 5 is a figure described the way of a die position recognition of a die bonder in a wafer.

FIG. 6 is a flow chart described the processes of a die position recognition of a die bonder in a wafer.

The die bonder 10 needs to recognize a normal die D formed on a wafer precisely in order to pick up the die D on the wafer.

Here, the image of the wafer is taken with the optical system 15, and captured into the auxiliary storage 42b. Moreover, the wafer is inspected at each die in visual inspection of the wafer, map data M indicated normal/abnormal at each die are generated, and, when recognizing, the map data are transferred from the PC 90, thus taken in.

The die bonder 10 executes the position recognition of a die on a wafer as follows, so as to pick up a normal die D, in the way that the recognition program 201 is executed by the monitor-processing device 41.

It suffices to get the center position of the die (die center) so as to pick up the normal die D.

First, whether the die for inspection is normal or not is judged. Here, it is assumed that map data are stored as “1” in the case of normal, and map data are stored as “0” in the case of abnormal (FIG. 6: S01).

When the die D is normal (map data M: 1) (FIG. 5A), the pattern of the die D and the recognition pattern P are compared (S02), and gotten the center position of the die (S03).

The recognition pattern P is a mirror die (i.e. a die not to form a circuit pattern) whose size is the same as the normal die, and keeps the outline information of the mirror die as the data of the recognition pattern P. This recognition pattern P is generated by the recognition program 201 on the basis of design values of the die D or imaging of a normal die, and kept on the auxiliary storage 42b. The recognition pattern P is generated as only one kind, therefore, plural patterns, for example, the pattern for normal, or the pattern for abnormal, missing the outline, are not generated according to various cases so as to recognize one kind of the wafer.

When the die D is abnormal (map data M: 0), the pattern of the die D and the recognition pattern P are compared (S04), and judged whether they are comparable as pattern or not (S05).

The case judged that the die D is normal (map data M: 1) is the case that the outline of the die is not clear as shown in FIG. 5B, or that another pattern is formed on the wafer as shown in FIG. 5C. The case that another pattern is formed on the wafer means the die for test evaluation named “teg die” is formed on the wafer etc, and then, this teg die is dealt as abnormal.

If the pattern of the die D and the recognition pattern P are comparable, the center position of the die is gotten on the basis of the pattern of the die D (S06).

If the pattern of the die D and the recognition pattern P are not comparable, for example, the case that a pattern is not formed at the position, the center position of the die is gotten on the basis of dicing grooves (FIG. 5, D, S07). Dicing grooves are the grooves formed on the wafer for cutting dies.

Then, judged whether there is the next die D or not, if not, the processes are terminated; if there is the next die D, the approximate position of the next die D is gotten, the next die D is allowed as the object for inspection (S11), at last, the flow of the processes returns to S01.

Thus, on account of the present method of the present invention, you have only to prepare the recognition pattern of one kind of mirror pattern so that center positions of dies can be gotten precisely for both a normal die and abnormal die. Even if the pattern of the dies is missing, the approximate position of the dies of which the pattern is missing, can be recognized.

According to the present invention, it is possible to provide a die bonder which can recognize the position of a die precisely without regard to the condition of the die.

What is claimed is:

1. A die bonder comprising:
a imaging unit which takes an image of a wafer;
a storage unit which stores the image of the wafer taken by the imaging unit, a recognition pattern included the outline of a die formed on the wafer, and a recognition program;
an interface unit which received map data indicated that the die is normal or abnormal;
a monitor-processing unit which gets the position on the wafer of the die whose map data indicates normal, in the way that the die on the wafer is matched with the recognition pattern by executing the recognition program, and the center position of the die is gotten.

2. The die bonder according to claim 1,
wherein the recognition pattern is only one kind for the die of one design specification, and is used in order to get the center position of the die without regard to whether map data corresponded to the die is normal or abnormal.

3. the die bonder according to claim 1,
wherein the center position of the die is gotten by dicing grooves formed on the wafer, when the recognition patters and a pattern of the die are not comparable.

4. A method of position recognition of a die comprising the steps of:
storing to a storage unit, the image of the wafer taken by an imaging unit;
generating, by a monitor-processing unit, one kind of recognition pattern of the die included the outline of the die on the wafer, by means of executing a recognition program;
recognizing, by a monitor-processing unit, the center position of the die on the wafer, by means of executing a recognition program, in the way that the die is matched with the recognition pattern; and
getting, by a monitor-processing unit, the center position of the die for inspection on the wafer on the basis of the dicing groove of the die, by means of executing a recognition program, when the die is matched with the recognition pattern, and the pattern of the die and the recognition pattern are not comparable.
